(19) United States
(12) Patent Application Publication
(10) Pub. No.: US 2026/0071816 A1
(43) Pub. Date: Mar. 12, 2026

(54) TRANSPORTABLE SARGASSUM DRYING MACHINE

(71) Applicants: Andres de Antonio Simancas, Mexico City (MX); Raquel de Antonio Crespo, Homestead, FL (US)

(72) Inventors: Andres de Antonio Simancas, Mexico City (MX); Raquel de Antonio Crespo, Homestead, FL (US)

(21) Appl. No.: 18/827,596

(22) Filed: Sep. 6, 2024

(51) Int. Cl. F26B 15/18; F26B 3/02; F26B 19/00; F26B 21/00

(52) U.S. Cl. CPC F26B 15/18; F26B 3/02; F26B 19/005; F26B 21/002; F26B 2200/02

(57) ABSTRACT

The present invention relates to a transportable sargassum drying machine that comprises several subsystems incorporated to achieve the objective of the invention. These subsystems consist of transportation and stabilization, a solar heating system that includes cylindrical parabolic solar heaters that heat thermal oil up to a temperature of 330° C.; hot air generation, which is directed to the conveyor belt and buckets to dry the sargassum; a drying process in which hot air from the radiators passes through the conveyor belt, evaporating moisture from the sargassum as it is transported; a multi-stage conveyor belt system with three conveyor belts, achieving a moisture content of 14% or less; a packing process where the sargassum is transported to a packing machine for shipping and transport; and power supply, where the machine's electrical devices are powered by photovoltaic solar panels attached to the side walls of the trailer.

### FIELD OF THE INVENTION

This invention pertains to the technical field of collecting and harvesting sargassum for the purpose of cleaning coastlines affected by these algae and its subsequent use in construction and other economic activities. More specifically, it relates to the technical field of drying and transporting sargassum at an industrial level, based on the properties of this brown algae.

Within the industry focused on generating and obtaining construction materials that replace the use of wood and other materials, numerous materials have been developed. However, one material that has not been fully utilized is sargassum, which is collected from the seas and oceans to undergo a variety of treatments, such as initial collection, drying, grinding, compaction, and other processes depending on its final use as raw material.

The large accumulations of sargassum that are not removed from beaches also promote erosion by forming ridges that, depending on the wind, tide, and waves, can carry away large volumes of sargassum mixed with conglomerated sand. It is important to highlight that when the drying process cannot be carried out in thin layers due to the large volume of sargassum, a wet and anaerobic decomposition occurs, generating gases and leachates that are highly toxic to the environment and human health. Additionally, the change in the composition and coloration of the sands limits their subsequent use for replenishing the beaches, especially if these are nesting sites for sea turtles.

### BACKGROUND OF THE INVENTION

Therefore, in the current management of sargassum on beaches, it is recommended to always collect fresh or newly arrived sargassum from the shoreline using wheelbarrows or light vehicles designed for this purpose. The sargassum should be spread in layers 10 cm thick whenever possible, avoiding the formation of ridges that contribute to erosive processes, and allowing it to dry in the sun on the beach itself.

In the past 15 years, regions such as the Caribbean, the Gulf of Mexico, and Florida, among others, have experienced an excessive influx of algae known as sargassum, which has negatively impacted both the environment and the economic activities in these areas. Annually, almost one million tons of sargassum reach the Gulf of Mexico from the Sargasso Sea in the Atlantic Ocean. This seaweed has various uses; it is a source of amino acids, vitamins, proteins, and other polysaccharides, it is used as a soil conditioner due to its nutrient content, it is converted into biofuels, or used as livestock feed. One interesting alternative use of sargassum is its application after drying, a process that aids in its preservation and handling, as a source of thermal energy or as a composting medium for treating contaminated soils. This work presents an analysis of the drying kinetics of sargassum in an indirect solar dryer. Four models were used: Newton, Page, Henderson and Pabis, and Midilli et al., (described in López-Callejas et al., 2009). The sargassum used was brought directly from the beaches of Cancún, Q.R., in a frozen state for conservation and analysis. To achieve drying with this method, a total of 10 hours was required, distributed over two non-consecutive periods, with measurements taken for solar radiation, temperature, and mass variation over time.

Currently, there are several techniques for drying sargassum, ranging from large areas for sun-drying, which is a very time-consuming technique and requires many resources to carry out, to plastic trays placed in columns for air-drying by suspension. There are also drying ovens that use fuels to operate, which generate high operational and maintenance costs.

To develop techniques for drying and transporting sargassum, the present invention has been developed as a technologically viable solution for the revalorization of the polluting waste from our seas and oceans, such as sargassum, a type of brown algae that poses an increasing environmental challenge in many coastal regions around the world. While it plays a crucial role in marine ecosystems, the excessive proliferation of algae has become a problem due to human activities like nutrient runoff and climate change. Large masses of sargassum that wash ashore can disrupt coastal habitats, negatively impact marine life, and hinder tourism and local fishing industries. One of the most pressing concerns is the accumulation of sargassum mixed with plastic waste, which exacerbates the problem of marine debris and threatens delicate ecosystems. However, with the present invention, we intend to address this issue in a creative and sustainable way by removing and drying the algae, which would otherwise be burdensome, and transforming it into a product ready for use in various industrial fields. In doing so, this invention makes a significant effort to alleviate the negative environmental impacts of sargassum proliferation and contribute to a cleaner and greener planet.

The prior art describes machinery such as machines that are “fixed” in an industrial facility, where it is necessary to transport large quantities of wet and/or damp sargassum in containers to undergo the drying process, which is not feasible due to the costs associated with transporting the weight and volume of sargassum, even in fresh conditions.

The utility model from the Chinese Patent Office, CN 214962522 U, discloses a continuous drying device for processing fusiform sargassum, which comprises a rack, a drive roller arranged at one end of the rack, a driving device arranged at one end of the drive roller, and a driven roller arranged at the other end of the rack. A conveyor belt is arranged between the driven roller and the drive roller, and a storage net cage is arranged on the conveyor belt, which is positioned on the rack. Handles are fixedly arranged at both ends of the storage net cage, a housing is fixedly arranged in the middle of the rack, and an infrared transmitter and an infrared receiver are correspondingly embedded in the inner walls of both sides of the housing. The fusiform sargassum drying device has the beneficial effects that the fusiform sargassum can be placed in the storage net cage for drying, enabling the quick collection of dried fusiform sargassum, and the sargassum is continuously dried through the conveyor belt.

The utility model from the Chinese Patent Office, CN 213096027 U, refers to equipment for drying and sterilizing fusiform sargassum, which comprises a drying oven, a plurality of drying conveyor belt groups, a natural gas combustion chamber, an air intake fan, and an air exhaust fan. The plurality of drying conveyor belt groups are arranged from top to bottom in the drying oven, and a hot airflow is formed between the air exhaust fan and the air intake fan to dry and sterilize the fusiform sargassum and remove dust. By adopting this scheme, the fusiform sargassum drying and sterilization equipment ensures that the fusiform sargassum is thoroughly dried during the drying process and can remove dust adhering to the surface of the fusiform sargassum.

The utility model from the Chinese Patent Office, CN 207936695 U, describes centrifugal sargassum drying equipment, which includes a drying barrel and an air blower. The exterior of the drying barrel is equipped with an insulating wall, and the internally mounted drying barrel has a main shaft. The middle part of the external main shaft is connected to algae stirring rods, and the upper and lower sides of the main shaft install the clamp material ring. The exterior of the clamp material ring is provided with an activity and presses from both sides of the material ring, and the right side of the activity presses from it. On both sides of the material ring, a coupling nut is installed. The internally mounted insulating wall has a heating strip, the top end connection of the main shaft has a motor, and the surface of the main shaft is provided with a ventilation hole. The right side of the air blower is connected to the trachea, and below the trachea is a liquid drain for leakage, with filter screens installed on the left and right sides of the trachea. This centrifugal sargassum drying equipment is equipped with an air blower, and the airflow that enters the main shaft through the trachea can continue through the air blower to blow air onto the surface of the sargassum through the ventilation hole, supplementing the centrifugal drying operation of the sargassum.

The utility model from the Chinese Patent Office, CN 219438153 U, discloses a ventilation device for clean fusiform sargassum, consisting of sets of grids, an aeration table surface, a gradually shrinking collection opening, a support shaft, and a rotating shaft. The two sets of grids are arranged such that the support shaft is positioned on one set of grids, and the rotating shaft, capable of rotating, is positioned on the other set of grids. The front side of the lower end of the aeration table is fixedly connected to the rotating shaft and can rotate to one side along with the rotating shaft. A groove is formed on the rear side of the lower end of the ventilation table, which is used to embed the rotating shaft, keeping the surface of the ventilation table stable. A discharge opening is formed on the side face of the front end of the upper ventilation table, and a gradually shrinking collection opening connected to the surface of the ventilation table is formed at the discharge opening. The air-drying table has the advantages that the two sets of grids keep the air-drying table stable, movable, and detachable, and the design of the grooves ensures firm fixation. Due to the design of the conical collection opening, the fusiform sargassum can be collected after lifting the rear end of the ventilation table, and the collection process is thorough.

The utility model from the Chinese Patent Office, CN 219698980 U, describes a hot air-drying device for fusiform sargassum, which comprises a cabinet body and cabinet doors. The three cabinet doors are vertically installed on the side face of the cabinet body at equal intervals, with a feed port and a discharge port formed at the top and bottom of each cabinet door, respectively. Sealing plates are installed on the feed port and the discharge port, respectively, and a circulating feeding mechanism is installed on each cabinet door. According to the fusiform sargassum hot air-drying device, the circulating feeding mechanism matches the feed port and the discharge port, allowing feeding and discharging without the need to open the cabinet doors, thereby reducing internal heat loss. This prevents the need for frequent high-intensity operation of the heating unit, maintains a constant internal temperature, and improves drying efficiency. Work efficiency can be enhanced, energy loss can be reduced, and the feed port and discharge port can be sealed and locked through the sealing plate, preventing heat dissipation when feeding and discharging are paused. This ensures that normal feeding and discharging can occur without being blocked, thus improving the efficiency of feeding and discharging.

The utility model from the Chinese Patent Office, CN 217423903 U, describes a dehydration and drying device for processing fusiform sargassum with a novel structural design. It comprises an installation frame, a box body installed on the outer wall of the top part of the installation frame through bolts, a transmission rod distributed in a horizontal structure that is movably installed in the box body through a bearing, and a transmission wheel installed on the outer wall of the transmission rod through bolts. The outer wall of the transmission wheel is lined with a transmission belt. A movable groove is formed on one side of the interior of the box body, and a driving rod and a driven rod extending inside the box body are movably installed in the movable groove through corresponding bolt bearings. According to the fusiform sargassum drying device, due to the arrangement of the compression roller and the auxiliary roller, the device can effectively roll materials, reducing the moisture in the fusiform sargassum. This overcomes the defect that the drying time of fusiform sargassum is increased due to the inability of an existing device to reduce moisture in the fusiform sargassum. The viability and general performance of the device are thus improved.

The Chinese patent application document CN 112006302 A describes a drying device for fusiform sargassum that comprises an air-drying frame with a support function, a transmission mechanism, a plurality of telescopic pieces coupled with fusiform sargassum, an air supply mechanism, and a transport mechanism. Through-holes are fully distributed on the surface of each telescopic piece; both ends of each telescopic piece are movably arranged in the air-drying frame. The transmission mechanism is arranged on one side of the air-drying frame and can drive the multiple telescopic pieces to complete the telescopic operation simultaneously. The air supply mechanism is arranged on the other side of the air-drying frame and can supply air to the multiple telescopic pieces at the same time. The transport mechanism is located below the multiple telescopic pieces, arranged in the air-drying frame, and used to receive fusiform sargassum falling from the multiple telescopic rods and transport the fusiform sargassum to one end. The fusiform sargassum drying device has the following advantages and effects: the fusiform sargassum drying device can dry fusiform sargassum and collect the dried fusiform sargassum.

However, none of the aforementioned documents disclose a transportable sargassum drying machine like the present invention, nor do they describe the operation and advantages of the present invention over prior techniques for drying sargassum, which will be described later in this patent application.

### SUMMARY

The essence of the present invention not only addresses the removal of these algae from the environment but also provides a practical application for the collected biomass. By converting sargassum into material suitable for industrial applications, the transportable sargassum drying machine of this invention actively contributes to environmental conservation and supports a circular economy that benefits both coastal communities and the planet.

The market for sargassum utilization is broad and continues to grow as it is an increasingly abundant resource, making it applicable in industries such as construction, food, medicine, textiles, and many others, with construction being the primary industry. These industries demand high-quality construction materials and eco-friendly packaging solutions. Our machine is designed to meet the needs of these sectors, providing a sustainable and innovative alternative as a raw material.

Additionally, companies and individuals seeking more eco-friendly construction solutions and environmentally responsible products will also be part of our target market. As the demand for green and sustainable products grows, our transportable sargassum drying machine presents an attractive option for those looking to make a positive environmental impact while meeting the requirements of their projects.

Our transportable sargassum drying machine is designed to be mobile, meaning it can be taken and placed wherever it is needed, saving resources by allowing the sargassum to be dried “in situ” for faster and better processing. This facilitates transporting the sargassum without the weight and volume of “fresh” sargassum, functioning similarly to a trailer or semi-trailer. Its transportability allows it to be brought directly to beaches affected by sargassum, ensuring immediate processing and preventing the algae from decomposing. This also eliminates the water content, making transportation more efficient and less cumbersome.

Therefore, one of the objectives of the present invention is to bring the transportable sargassum drying machine to locations where sargassum is found, saving resources in accessing it.

In our commitment to environmental preservation, we take pride in the fact that the drying process is powered solely by solar energy and/or heat, with temperatures reaching up to 180 degrees Celsius. With zero reliance on fossil fuels or organic solvents, our drying method ensures a minimal ecological impact. The days of harmful emissions are over, as our process produces no dust, fumes, or smog, safeguarding the atmosphere and local air quality.

Another objective of the present invention is to obtain sargassum as a “dry” raw material, which is then packed into “bales” that facilitate its handling and transportation to processing plants that may be far from the beach areas where the sargassum is collected, thereby saving on costs and logistics for the products to be manufactured from the sargassum.

### BRIEF DESCRIPTION OF THE DRAWINGS

The figures accompanying this patent specification are as follows, which are illustrative and not limiting:

FIG. 1 A general view of the transportable sargassum drying machine of the present invention.

FIG. 2 A view of the machine of the present invention showing solar panels arranged on the side walls of the trailer and the thermal oil heaters on the roof of the trailer of the present invention.

FIG. 3 A view of the interior of the trailer of the present invention showing the drying system of the transportable sargassum drying machine of the present invention.

FIG. 4 A detailed view of the sargassum conveyor belts of the drying machine of the present invention.

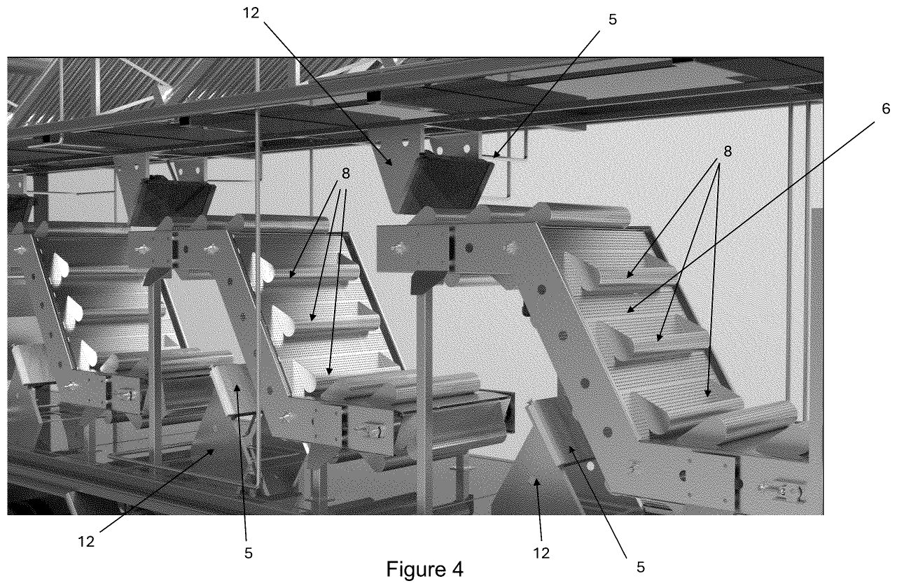

### DETAILED DESCRIPTION

The present invention aims to make the most of the waste from our seas and oceans that has caused significant pollution on our beaches, specifically the algae known as sargassum.

The increase in sargassum on our beautiful coasts is not just a fleeting concern; it is a growing challenge that demands our attention. Some companies are dedicating substantial budgets of $4 to $6 million annually to keep our beaches pristine, yet the problem persists. The question of what to do with the collected biomass remains unanswered.

Staggering figures reveal the magnitude of the sargassum challenge we face. According to NASA images, this year, an astounding 13 million tons of the notorious foul-smelling algae have accumulated in the Great Atlantic Sargassum Belt, highlighting the urgency of finding effective and sustainable solutions. This is not just a local problem; it is a global concern that demands our collective action. Through innovation and collaboration, we can transform this challenge into an opportunity for positive change.

Recent studies have revealed a troubling discovery within the sargassum phenomenon. Researchers have found elevated levels of bacteria in sargassum algae, raising concerns about its potential impact on marine ecosystems and public health. These findings underscore the complex nature of the sargassum challenge and reveal the need for comprehensive approaches that address both its ecological implications and its potential consequences for human interactions with coastal environments.

The transportable sargassum drying machine is designed to be mobile, functioning similarly to a trailer or semi-trailer. Its transportability allows it to be taken directly to beaches affected by sargassum, ensuring immediate processing and preventing the algae from decomposing. This also removes the water content, making transportation more efficient and less cumbersome.

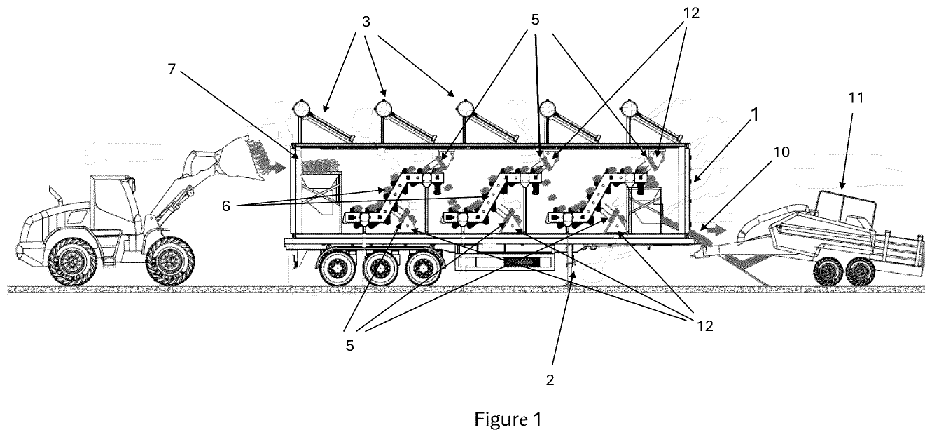

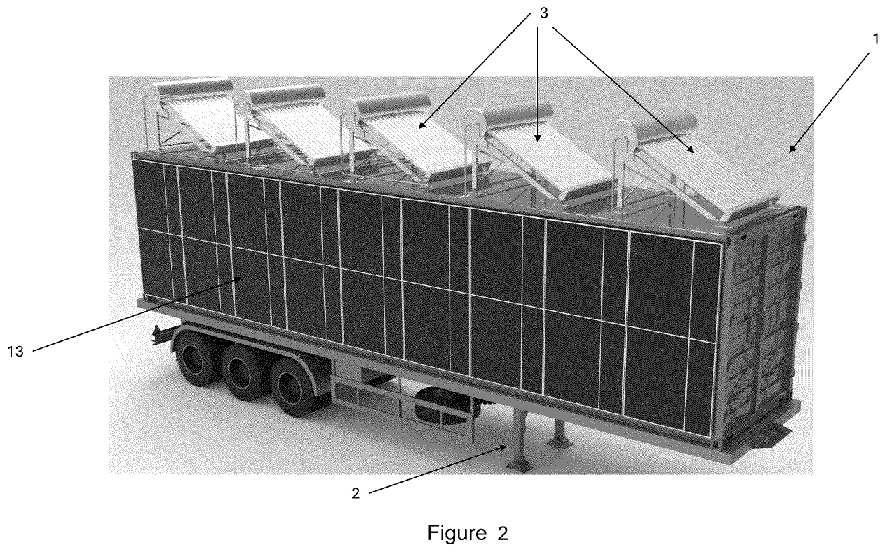

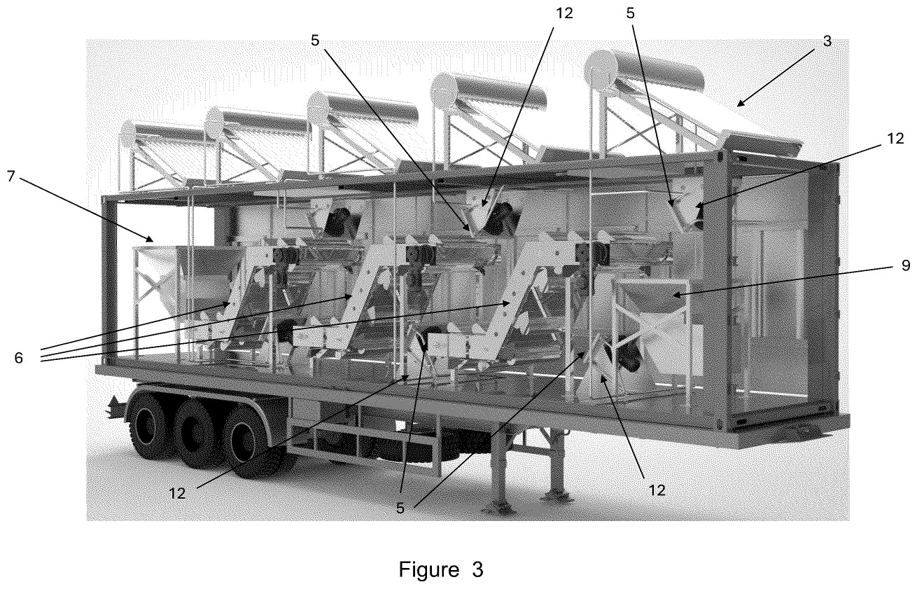

In a first aspect of the invention, a transportable sargassum drying machine is described, which comprises several subsystems incorporated to achieve the objective of the invention. These subsystems consist of:
Transport and Stabilization: The present invention, as shown in FIGS. 1 and 2, consists of a trailer or semi-trailer (1) that functions as the housing for the transportable sargassum drying machine of the present invention. This trailer is towed by a standard 10-wheel or more tractor or truck (not shown), allowing the drying machine to be transported to any location to work “in situ” and process the necessary sargassum. The stabilization of the machine is achieved using telescopic stabilizers (2) located on the lower part of the trailer or housing (1), either at the rear and/or front of the machine, in conjunction with the trailer's wheels. These stabilizers are conventional stabilizers used by trailers when uncoupling from the tractor or truck.
Solar Heating System: As shown in FIGS. 2 and 3, the top part of the trailer (1), meaning the roof of the machine, is equipped with cylindrical parabolic solar heaters (3) that heat thermal oil (Paratherm) in a central tube, where the thermal oil can reach temperatures of up to 330 degrees Celsius.
Hot Air Generation: The heated thermal oil then passes through radiators (5) known as hot air producers, which are very similar to large-scale truck radiators, with an electric motor (not shown) and a fan (12). The air is heated to a temperature of 140 to 150 degrees Celsius. There are three radiators located just above the conveyor belts (6), meaning above the highest point of the conveyor belt, and another three radiators (5) below these conveyor belts (6), each radiator (5) equipped with a fan (12), as explained further below.
Drying Process: As shown in FIG. 1, a tractor with a front loader loads wet or damp sargassum from the beach into a rear hopper or feed hopper (7) located at the back of the trailer or housing (1). The feed hopper (7) discharges the sargassum onto the conveyor belt system (6); the conveyor belt system (6) is equipped with perforated buckets (8), and both the conveyor belts (6) and the buckets (8) are made of a perforated material that allows hot air from the radiators (5) to pass through them. This process evaporates the moisture from the sargassum as it is transported from one conveyor belt (6) to another, drying the sargassum and then depositing it into a discharge hopper (9) located at the front of the trailer (1). In this way, the hot air escapes from the trailer through the rear, above the feed hopper (7).
Multi-Stage Conveyor Belt System: As shown in the figures, the transportable sargassum drying machine is equipped with at least three conveyor belts (6), which are perforated and have perforated buckets (8). As the sargassum is deposited into the feed hopper (7), it passes from the first conveyor belt (6) to the second conveyor belt (6), and since it is exposed to a stream of hot air, the sargassum loses moisture and continues to dry. After passing through at least three conveyor belts (6), the sargassum is finally deposited into the discharge hopper (9), reaching a moisture content of 14% or less.
Packing Process: As shown in FIG. 1, the dried sargassum falls into the discharge hopper (9), where it is carried by a discharge conveyor belt (10) to a packing machine (11). The packing machine (11) compresses the dried sargassum into high-pressure bales with uniform dimensions, ready for shipping and transport. The packing machine (11) is mounted on the trailer using a detachable steel ramp.
Power Supply: The conveyor belts (6) are powered by electric motors, conventional belts, and pulleys (not shown), as well as the fans (12), which are driven by conventional electric motors, and the packing machine (11) are powered by photovoltaic solar panels (13) attached to the side walls of the trailer or housing (1). These panels can be folded up onto the roof of the trailer (1); that is, when the machine is in a non-operational state, these panels are positioned vertically, forming the side walls of the trailer (1), and when the machine is in operation, the photovoltaic solar panels (13) are positioned horizontally or at an optimal angle to better capture sunlight for improved solar energy utilization. This design ensures that the machine is designed to be carbon-neutral, always using solar energy.

This design guarantees efficient and sustainable drying and packing of the sargassum, preparing it for further processing and transportation, while also halting the decomposition process and addressing the logistical challenges associated with transporting wet seaweed.

Returning to the technical features that make up the present transportable sargassum drying machine, as indicated above and more specifically in the presented figures, the sargassum, once collected from the beaches, is deposited into a feed hopper (7) located inside a trailer or housing (1). Due to gravity, the sargassum falls onto the first conveyor belt (6), which is driven by an electric motor, belts, and pulleys (not shown) and is positioned at an upward incline. This belt consists of a series of buckets (8) that scoop up the sargassum and elevate it via the conveyor belt (6), as illustrated in FIGS. 1 and 3. While the sargassum is lifted by the buckets, a stream of hot air is circulated transversely through the perforated conveyor belt (6) and the buckets (8). This hot air comes from a fan (12) located below the conveyor belt (6). The fan (12) pushes the air through a radiator (5), also positioned below the conveyor belt (6), between the fan (12) and the conveyor belt (6). As mentioned earlier, the radiator (5) contains hot oil supplied by a series of cylindrical parabolic solar heaters (3) located on the top (roof) of the trailer (1) through a network of pipes. The air absorbs heat from the radiator (5) and flows through the perforations in the conveyor belt (6) and buckets (8), drying the sargassum as it is lifted. Once the sargassum reaches the top of the conveyor belt (6), another stream of hot air is circulated transversely directly toward the sargassum and through the conveyor belt (6) and buckets (8). This hot air comes from another fan (12) located above the conveyor belt (6), above the highest point of the conveyor belt (6). The fan (12) pushes air through another radiator (5), also positioned above the conveyor belt (6), between the fan (12) and the conveyor belt (6). As mentioned earlier, like the radiator positioned below the conveyor belt (6), this radiator (5) also contains hot oil supplied by the solar heaters (3) located on the top (roof) of the trailer (1) through a network of pipes. The air absorbs heat from the radiator (5) and flows through the sargassum, drying it as it moves along the top of the conveyor belt.

Once at the top of the conveyor belt (6), the sargassum continues its path along the belt and as shown in FIG. 1, falls by gravity to the base of a second conveyor belt (6) that is adjacent to the previously described conveyor belt (6). This second conveyor belt (6) is constructed and operates in the same manner as the previously described conveyor belt (6), where the sargassum again receives two new streams of hot air to continue the drying process. After traveling along the second conveyor belt (6), the sargassum falls by gravity onto the base of a third conveyor belt (6), which, like the first and second conveyor belts, is equipped with buckets (8), radiators (5), and fans (12), arranged as described for the first conveyor belt (6).

As shown in FIG. 1, once the sargassum reaches the top of the third conveyor belt (6), it falls, now dry, into a discharge hopper (9), where it is carried by another conveyor belt (10) to a packing machine (11). Finally, the sargassum is compacted under high pressure into “bales” with predetermined dimensions, ready to be transported and/or used for any industrial or commercial purpose.

It is important to note that to have hot oil within the radiators (5) of the present invention, the oil is supplied from a plurality of solar heaters (3) located on the top of the trailer (1). These heaters utilize solar energy to heat the thermal oil up to 330° C. This thermal oil is then circulated to the various radiators (5) through a piping system designed to distribute the oil to each radiator, maximizing its thermal energy throughout the entire sargassum drying process.

Additionally, it is essential to mention that since the transportable sargassum drying machine described in this application is committed to clean, CO2 emission-free technologies, and because it is a machine primarily intended for use directly on beaches where sargassum is abundant and where electrical power is often unavailable, this machine is equipped with a power supply system. This system provides energy to the motors of the various conveyor belts (6, 10), the different fans (12), the packing machine, the pumping equipment for circulating the thermal oil through the various radiators (5), as well as to the monitoring and control equipment (not shown) of the present invention. The power supply system consists of a series of photovoltaic solar panels (13) attached to the side walls of the trailer (1). These panels can be folded up onto the roof of the trailer (1); in other words, when the machine is in a resting or non-operational state, the panels are positioned vertically, forming the side walls of the trailer (1). When the machine is in operation, the photovoltaic solar panels (13) are positioned horizontally or at an optimal angle to better capture sunlight, thus optimizing solar energy use. As a result, the machine is designed to be CO2 neutral, always using solar energy.

1. A transportable sargassum drying machine comprising a trailer or housing (1), wherein inside said trailer (1), specifically at the rear part of said trailer (1), there is a feed hopper (7) that receives wet or damp sargassum; downstream of said feed hopper (7) and toward the front part of said trailer (1), there is a first conveyor belt (6) that receives said sargassum, wherein said first conveyor belt (6) is inclined and moves upward. Said conveyor belt (6) is equipped with a plurality of buckets (8) that transport the sargassum to the top of said conveyor belt (6), where, as the sargassum ascends the conveyor belt (6) and when it reaches the top of said conveyor belt (6), the sargassum is dried by hot air currents. Adjacent to said first conveyor belt (6) is a second conveyor belt (6) arranged and equipped with the same characteristics as the aforementioned first conveyor belt (6), where the sargassum that reaches the top of the first conveyor belt (6) continues its trajectory and falls onto the second conveyor belt (6), where, as the sargassum ascends the second conveyor belt (6) and also when it reaches the top of said second conveyor belt (6), the sargassum is dried by hot air currents, just as it was during its passage on said first conveyor belt (6). Adjacent to said second conveyor belt (6) is a third conveyor belt (6) arranged and equipped with the same characteristics as the aforementioned first and second conveyor belts (6), where the sargassum that reaches the top of the second conveyor belt (6) continues its trajectory and falls onto the third conveyor belt (6), where, as the sargassum ascends the third conveyor belt (6) and also when it reaches the top of said third conveyor belt (6), the sargassum is dried by hot air currents, just as it was during its passage on said first and second conveyor belts (6). The sargassum that reaches the top of the third conveyor belt (6) continues its trajectory and falls into a discharge hopper (9); adjacent to the discharge hopper (9) is another conveyor belt (10) that transports the sargassum to a packing machine (11). This transportable sargassum drying machine also comprises, on the top and above the trailer or housing (1), a plurality of cylindrical parabolic solar heaters (3) arranged to heat thermal oil; characterized in that within the trailer or housing (1) and positioned below each of the three conveyor belts (6), a fan (12) is arranged to blow air toward the conveyor belt (6); and a radiator (5) positioned between the fan (12) and the conveyor belt (6), through which the thermal oil from the plurality of cylindrical parabolic solar heaters (3) flows. The air blown by the fan (12) absorbs heat from the thermal oil, forming the hot air stream that dries the sargassum as it ascends the conveyor belt (6) and buckets (8). Also, positioned above each of the three conveyor belts (6) and above the highest point of the conveyor belt, a fan (12) is arranged to blow air toward the top of the conveyor belt (6); and a radiator (5) positioned between the fan (12) and the conveyor belt (6), through which the thermal oil from the plurality of cylindrical parabolic solar heaters (3) flows, causing the air blown by the fan (12) to absorb heat from the thermal oil, forming another hot air stream to dry the sargassum that has reached the top of the conveyor belt (6).

2. The transportable sargassum drying machine according to claim 1, characterized in that it also comprises a plurality of photovoltaic solar panels (13), which are attached to the side walls of the trailer or housing (1). These panels can be folded up onto the roof of the trailer (1); in other words, when the machine is in a resting or non-operational state, these panels are positioned vertically, forming the side walls of the trailer (1), and when the machine is in operation, these photovoltaic solar panels (13) are positioned horizontally or at an optimal angle.

3. The transportable sargassum drying machine according to claim 1, characterized in that both the conveyor belts (6) and the buckets (8) are made of a perforated material that allows the hot air from the radiators (5) to pass through them.

4. The transportable sargassum drying machine according to claim 1, characterized in that the stabilization of the machine is achieved using telescopic stabilizers (2) located on the lower part of the trailer or housing (1), either at the rear and/or front of the machine, in conjunction with the trailer's wheels.

5. The transportable sargassum drying machine according to claim 1, characterized in that the cylindrical parabolic solar heaters (3) that heat the thermal oil can raise the temperature of the thermal oil to 330° C.

6. The transportable sargassum drying machine according to claim 1, characterized in that the air is heated to a temperature of 140 to 150° C.

7. The transportable sargassum drying machine according to claim 1, characterized in that the packing machine (11) is mounted on the trailer (1) using a detachable steel ramp.

8. The transportable sargassum drying machine according to claim 2, characterized in that the energy to power the electric motors of the conveyor belts (6), the motors of the fans (12), the thermal oil pumping equipment, and the packing machine (11), as well as the control and monitoring equipment, is obtained from the photovoltaic solar panels (13).
